(19) United States
(12) Patent Application Publication
(10) Pub. No.: US 2016/0346699 A1
(43) Pub. Date: Dec. 1, 2016

(54) Game Providing for Virtual Fantasy-Leagues

(71) Applicant: VIRTUAL2 LEAGUES, Whitewater, WI (US)

(72) Inventors: Andrew Jones, Indianapolis, IN (US); Larry Hummel, JR., Greenwood, IN (US)

(21) Appl. No.: 15/164,190

(22) Filed: May 25, 2016

Related U.S. Application Data
(60) Provisional application No. 62/166,229, filed on May 26, 2015.

(51) Int. Cl. A63F 13/828; A63F 13/35

(52) U.S. Cl. CPC A63F 13/828; A63F 13/35

(57) ABSTRACT

A virtual fantasy-league game system provides a fantasy-league based not on an actual sporting event but on a simulated contest. The contest is constrained by rules that give it a degree of predictability similar to an actual sporting event thereby rewarding efforts by gameplayers to predict outcomes in seeking to win their fantasy-league.

### CROSS REFERENCE TO RELATED APPLICATION

This application claims the benefit of U.S. provisional application 62/166229 filed May 26, 2015 and hereby incorporated by reference.

### STATEMENT REGARDING FEDERALLY SPONSORED RESEARCH OR DEVELOPMENT

### BACKGROUND OF THE INVENTION

The present invention relates to a fantasy-league game where gameplayers compete with each other through fantasy-leagues, and wherein the gameplayers' success is based on the performance by virtual contestants in a separate external contest. In particular, the present invention relates to a fantasy-league game where the external contest is a simulation.

Fantasy football is a well-known fantasy-league game in which gameplayers create fantasy teams composed of actual professional football contestants. The gameplayers then have contests among each other where the outcome of the contest is determined by the actual performance of the professional football contestants captured by football game statistics. Gameplay statistics for each contestant are mapped to points in a scoring system and the total points for all of the contestants in a given gameplayer's roster determine the winner of the fantasy contest. The challenge to the gameplayers is in predicting the output of actual football games and managing their contestant rosters accordingly.

A variety of organizations including the National Football League collect the statistics from their games to present to fantasy gameplayers in a convenient fashion for fantasy-league play. These organizations may also manage the task of tracking total points for a gameplayer's roster and the like.

While fantasy-leagues can provide an additional way to enjoy sports such as football, they can be inaccessible to those who are uninterested in the underlying sport. In addition, players who are unfamiliar with a given sport may feel disadvantaged with respect to selecting a team roster compared to those who have long experience with the sport and its players, making the fantasy-league less attractive and less rewarding for those beginning players. The local nature of many sports largely precludes fantasy-leagues that span nations with different cultures and disjoint sporting interests.

### SUMMARY OF THE INVENTION

The present invention provides a fantasy-league game that is based not on an actual sporting event, but on a simulated contest. The simulated contest is constrained by contest rules that give it a degree of predictability similar to an actual sporting event, thereby rewarding efforts by gameplayers to predict outcomes in seeking to win in their fantasy-league. For example, the contest rules may include a story arc that provides the same rising and falling of contestant fortunes that can occur in the careers of actual sporting figures. Because the contest is simulated, however, it need not represent an actual professional league or even a sport, but can be expanded into a variety of different genres including science fiction, historical battles, and the like.

More specifically, at least one embodiment of the invention provides a virtual fantasy-league game system implemented on an electronic computer to provide a contestant table listing of contestant characteristics related to a virtual contest between contestants, environment tables describing a series of virtual contests between a set of contestants and a roster table providing for each gameplayer a roster of at least sonic of the set of contestants in a fantasy contest between contestants. A computer further implements a random number generator and a set of contest rules describing the determination of outcomes of the virtual contest using the contestant tables and environment tables with random numbers from the random number generator to produce a set of statistics. The statistics are used by a set of fantasy rules describing a determination of the outcome of the fantasy contests using the set of statistics applied to the roster for each gameplayer.

It is thus a feature of at least one embodiment of the invention to provide the enjoyment of fantasy football in a set of contests that may be more attractive to individuals having limited experience with or interest in football and other professional sports.

The contestant table may list contestant characteristics selected from the group consisting of intelligence, strength, health, and agility such as affect outcomes of the virtual contests according to the contest rules.

It is thus a feature of at least one embodiment of the invention to provide the ability to create a wide variety of different fantasy contests including science fiction, historical battles, or the like.

The contestant table may include contestant health which decreases during a contest and recovers between contests.

It is thus a feature of at least one embodiment of the invention to provide continuity between contests that encourages involvement by the gameplayers with the contest as an ongoing narrative.

The contestant table may further include equipment available to the contestant, the equipment affecting the outcome of the virtual contests according to the contest rules.

It is thus a feature of at least one embodiment of the invention to provide an additional dimension to the contests beyond that normally provided in professional sports contests.

The electronic computer executing the stored program further provides equipment purchase rules providing for the purchase by garneplayers of equipment assigned to specified contestants.

It is thus a feature of at least one embodiment of the invention to permit in-game purchases such as provide more direct involvement by the gameplayers in the contest than available in normal sporting events.

The environment tables may provide information about a location of a contest including at least one of weather and terrain type.

It is thus a feature of at least one embodiment of the invention to provide a set of varying environments that challenge the gameplayer's ability to assess contestants relative skills in these different environments, thus keeping each contest fresh.

The electronic computer may execute the stored program to further provide roster selection rules providing for the distribution of contestants among the rosters of the gameplayers according to gameplayer input.

It is thus a feature of at least one embodiment of the invention to provide the standard fantasy sports framework familiar to fantasy sport gameplayers.

The statistics produced by the contest rules may be output to the gameplayers.

It is thus a feature of at least one embodiment of the invention to provide transparency in the determination of winners under the fantasy rules.

A portion of the statistics produced by the contest rules are provided to human reporters who provide stories characterizing some statistics not provided directly to the gameplayers.

It is thus a feature of at least one embodiment of the invention to generate buzz and excitement with respect to the contest such as form part of the enjoyment of fantasy-leagues.

The virtual fantasy-league system may further include a story are table providing a set of weights for each contestant applicable to successive contests, the weights affecting outcomes of the virtual contests according to the contest rules.

It is thus a feature of at least one embodiment of the invention to provide an evolution of contests that fits a narrative framework invoking an additional dimension of gameplay or interest and prediction.

These particular objects and advantages may apply to only some embodiments falling within the claims and thus do not define the scope of the invention.

### BRIEF DESCRIPTION OF THE DRAWINGS

FIG. 1 is a block diagram showing the principal rule modules of a virtual fantasy-league game of the present invention including a virtual contest system, a league statistic system and a fantasy-league system;

FIG. 2 is a character DNA table used to define the characteristics of virtual contestants used by the virtual contest system;

FIG. 3 is a contestant are vector being part of the character DNA;

FIG. 4 is a flowchart of the steps implemented by the game module in determining the outcome of the contest between virtual characters;

FIG. 5 is a team roster form used by gameplayers in setting their team rosters;

FIG. 6 is a payout table produced by the league statistic system for indicating victors in the fantasy-league system;

FIG. 7 is a system of computers that may be used to facilitate gameplay of the virtual fantasy-league game of the present invention; and

FIG. 8 is a figure similar to that of FIG. 7 showing implementation of the virtual fantasy-league game using printed forms.

### DETAILED DESCRIPTION OF THE PREFERRED EMBODIMENT

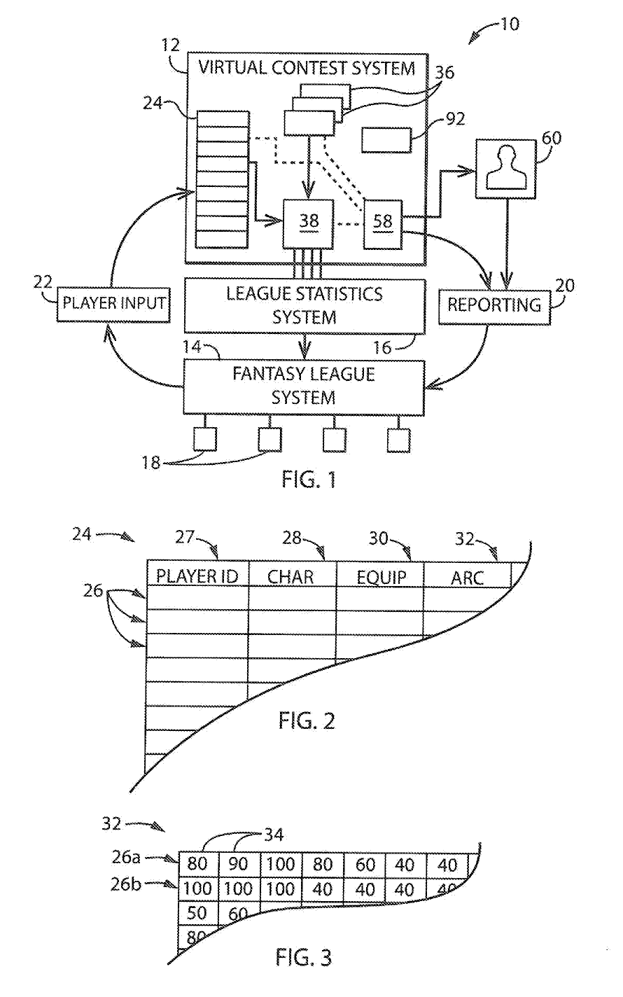

Referring now to FIG. 1, a virtual fantasy-league 10 of the present invention provides for a virtual contest system 12 operating in parallel with a fantasy-league system 14. In this regard the virtual contest system 12 operates in the manner of a professional football league in fantasy football, providing regularly scheduled contests in which statistics are generated and transmitted through a league statistics system 16 to the fantasy-league system 14. The fantasy-league system 14 is thus analogous to a fantasy football league system.

Gameplayers 18 communicate with the virtual contest system 12 through the fantasy-league system 14 where they receive statistics from the league statistics system 16. Gameplayers 18 may also receive reporting from reporting module 20, through the fantasy-league system 14, as will be described below and may influence the virtual contest system 12 through gameplayer input module 22, via the fantasy-league system 14 which will also be described below. Generally each of gameplayers 18 may have equal access to the league statistics system 16, reporting module 20 and contestant input module 22 moderated only by their interest and investment in the game.

The virtual contest system 12 is intended to provide a simulation of an actual contest between individuals that is constrained by consistent rules and thus has some level of predictability. Largely the rules are not directly known by the gameplayers 18 but may be derived imperfectly by observation of successive contests of the virtual contest system 12 and information from the reporting module 20.

Verisimilitude and consistency in the contests of the virtual contest system 12 are provided by a “DNA table” 24 providing information that characterizes the contestants in each contest. Referring also to FIG. 2, the information in the DNA table 24 may vary according to the particular type of contest being simulated but will generally include an entry for each of the potential contestants in a contest in the virtual contest system 12, for example, shown logically as a row 26 in DNA table 24. Each row 26 may include a contestant identification field 27, for example, providing the contestant name and unique identifier. This information will be consistent among the virtual contest system 12 and fantasy-league system 14 and allows the gameplayers 18 to track the performance of the virtual contestants of the contestant DNA table 24 and the draft of the contestants to their fantasy teams.

Each row 26 may also include multiple contestant characteristics fields 28 that describe characteristics of the contestants. For example, when the virtual contest is a fantasy-type contest, the characteristics may include a character type (e.g., magician, thief, archer, etc.) as well as various characteristics of the contestants (e.g., intelligence, strength, health, agility, etc.); these characteristics may further include, for example, the character's experience, physical size, resilience and other virtues. Character types may control the range of other contestant characteristics (for example, a thief may have a lower range of strength than an archer) or may give the character special abilities. One important characteristic is the contestant health or “hit points” which will generally fluctuate downward during a contest and recover between contests and which determines how long the contestant may continue in the contest.

As well is the inherent qualities of the contestants, each row may provide for one or more equipment fields 30 describing equipment or other resources owned by and thus available to the contestant. In the fantasy-type contest, for example, the equipment field may describe weapons, magical potions, and money, the latter of which may be converted into other equipment.

The DNA table 24 may further include a contestant arc field 32 which describes generally the dramatic arc of the contestant. This information is not available to the gameplayers 18 but allows realistic evolution of the characters over time that provides dramatic interest to successive contests. Referring momentarily to FIG. 3, each contestant are field 32 may provide for a vector of contestant performance weights 34 at different times over the contestant's career that may be used to weight the performance of the contestant in the battle module 38 as will be described below. Thus, for example, a first contestant represented by row 26a may show generally increasing ability that rises over time whereas a second contestant represented by row 26b may start strong and then falter as time progresses. Attempting to deduce these patterns will be part of the challenge presented to the gameplayers 18.

Referring again to FIG. 1, the virtual contest system will also provide for a set of environment tables 36 which define scheduled contests and the environment of the contests. Some of the content of the environment tables 36 will be available to the gameplayers 18 in the manner of football contestants knowing a schedule of games and the time and location of those games. In this case, however, the environment tables 36 may describe a more complete and varied set of environmental factors. For example, a battle may take place in a swamp or in a mountainous region. The environment tables 36 may describe the weather or other factors that could influence the contest. The environment tables 36 may also described the contestants that will participate in each contest according to the contestant ID. The list of the contestants may vary depending on the outcome of earlier contests or other factors which may eliminate some contestants and require that others be substituted for them.

In this regard, the term battle should be understood to broadly include any contest or challenge and may be not only an armed battle but equally any struggle between sets of players against other players, or by players against any challenge, for example, the finding or exploitation of resources or the like or the withstanding of natural disasters or other external forces.

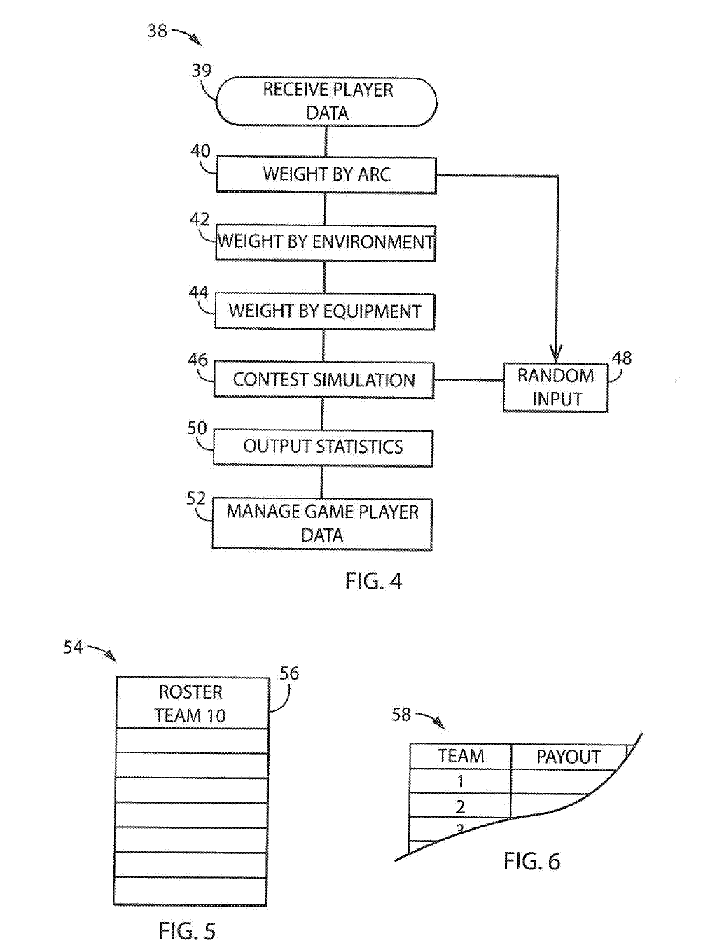

Referring now to FIGS. 1, 2 and 4, the contestant DNA table 24 and the environment tables 36 are provided to a battle module 38 which then creates a simulated battle between particular contestants of the DNA table 24 in an environment selected from the environment tables 36. As indicated by process block 39, the first step of this process retrieves contestant data for the particular contest which may, for example, be incorporated in the environment tables 36 which broadly define a set of successive conflicts. In one embodiment, each of the numerical values in each of the contestant characteristics fields 28 for the contestants in this contest is then weighted by the vector contestant performance weights 34 of the contestant arc field 32 as indicated by process blocks 40 for the current contest time of the environment table 36. This weighting may simply employ a multiplication of the vector contestant performance weights 34 by each of the values of the characteristics fields 28, for example, the contestant health or agility, which are then changed according to the arc.

The values of the characteristics fields 28 and the equipment fields 30 may then be weighted according to other aspects of the environment in the environment table 36, as indicated by process block 42. This weighting may also affect the values of the characteristics fields 28, for example, decreasing a virtue such as keen eyesight when the environment is foggy or rainy. Alternatively or in addition, this weighting may affect the characteristics of the equipment, for example, decreasing the benefit of a bow and arrow in a heavily wooded environment. Generally, the weighting may employ a set of rules developed in advance for the particular genre of the competitions based on normal logical understandings of the effects of environment on actual physical constructs or the likely physical interpretation of fantasy constructs. In this way, gameplayers 18 may successfully reason about the outcome of future contests based on their knowledge.

According to process blocks 44, the values of the characteristics fields 28 are then weighted by the previously weighted equipment fields 30 to provide a set of weighted characteristics for a particular battle for each contestant. Thus, for example, a better bow may affect an increase in character strength for an archer. At a beginning of the battle, each contestant's health is increased by a percentage to represent a convalescence time since the last battle.

The battle may then be simulated, as indicated by process block 46, which in its simplest form may provide for a sequence of “skirmishes” in which a random input 48 is received to determine how the contestant fares during each skirmish. It will be appreciated that the application of the random input 48 to the skirmishes may follow a set of rules, for example, that pairs contestants against other specific contestants and then determines an outcome by comparing the information from the DNA table 24 and the environment table 36 plus a random value that prevents the comparison from being perfectly deterministic. The outcome iteratively creates new values for the contestant DNA table 24 for the next skirmish.

The random input 48 may also be guided by the values of the contestant arc field 32 per process block 40 which can constrain the range of random variables of the random input 48 to affect a desired arc. In this way, the random nature of the contest can nevertheless be yoked to a desired dramatic arc while still preserving a degree of randomness.

Predominantly the contestant health and equipment will evolve during the skirmishes. Significantly, during the modification of the contestant health and equipment, statistics will be generated, for example, with successful blows landed on an opponent decreasing that opponent's health while successful defenses against attacks by an opponent mitigate a returning health reduction. “Loot” obtained when an opponent is vanquished (that is, no longer has the health to continue in the battle) may be added to the equipment of the DNA table 24 for the successful contestant. The environment may also yield statistical elements including additional equipment uncovered. These statistics will form the basis for the league statistics system 16 as transferred to the fantasy-league system 14.

In one implementation, the battle module 38 for each skirmish will provide a set of arithmetic functions which receive as arguments random variables and values from the DNA table 24 and the environment table 36 to generate the ancillary statistics and the effects of health/health and equipment.

At the conclusion of the contest provided by the battle module 38, statistics are output as indicated by process blocks 50, and at process block 52 gameplayer data sets may be updated automatically for the convenience of the gameplayers 18.

In this latter regard, and referring to FIG. 5, for each contest of the battle module 38, each gameplayer 18 will have drafted a number of contestants from the DNA table 24. This drafting process may, for example, employ a round-robin procedure where in each turn a gameplayer 18 may select one contestant from the DNA table 24. The gameplayers 18 then select a subset of their drafted contestants for a roster 54 that will comprise the contestants for a given round of the fantasy contest. In between battles conducted by the virtual contest system 12, a gameplayer 18 may trade contestants, or add and drop contestants from the roster 54. The contestants are listed in the roster 54 according to their identification numbers per field 27 and each roster 54 is linked to a fantasy team name 56 or other identification then fixed at the time of the beginning of the contest.

At the conclusion of the contest, the statistics for each battle conducted by the battle module 38 will be communicated through the league statistics system 16 to the fantasy-league system 14. The points obtained for each fantasy team roster 54 may be presented in an outcome table 58, for example, listing the fantasy teams and a payout, that being the number of points afforded to the fantasy team based on the statistics output at process block 50. Generally this number of points will be a simple algebraic formula (typically visible to the gameplayers) accepting as arguments the statistics and outputting as values the payout according to techniques well known in the art of fantasy football. For example, each successful attack against an opponent may obtain a certain number of points and acquiring loot may have a certain number of points, and these points added together provide a payout value.

Referring now again to FIG. 1, the virtual contest system 12 may further include a reporting module 20 which provides additional information about the contests run by the battle module 38 beyond the statistics reported to the league statistics system 16. This reporting module 20 may draw information from any or all of the battle modules 38, environment tables 36, and the DNA table 24. The reporting module 20 provides for “hype and flavor” of the type produced by actual news organizations surrounding a professional sports team. In this regard some of the information is sent directly to the reporting module 20 and then is provided directly to the fantasy-league system and hence to the gameplayers 18. For example, changes in the character field 28 not evident in the game statistics showing contestant performance, injuries, etc., may be provided as well as though statistics necessary for calculation of the fantasy contest winners. In addition, some information is provided only to human reporters 60 who may craft stories based on the contests including fictional embellishments that add life to the contests. In this regard, the reporters 60 which may, for example, be designated individuals, may have access to current or future information not available to the gameplayers 18, for example, the contestant arc field 32 so that this information can help them create compelling dramatic storylines. Nevertheless the output of the human reporters 60 is provided to all of the gameplayers 18 within a gameplayers elected participation levels. The ability to be a reporter may be a reward for successful gameplay or may be a purchase item. Typically the reporters will be precluded by conflict of interest from participating in the contests as a fantasy gameplayer. Information provided only to reporters will not normally be considered a statistic on which fantasy contest points are determined.

The gameplayers 18 may also be allowed a limited influence on the virtual contest system 12 by means of input module 22 which may include, for example, allowing in-game purchases by gameplayers 18 allowing gameplayers 18 to purchase equipment items for particular contestants of the DNA table 24 to assist those contestants, these purchases at the values of the equipment field 30. This assistance may be implemented automatically or through another set of human intermediaries who may serve as brokers or equipment manufacturers or the like.

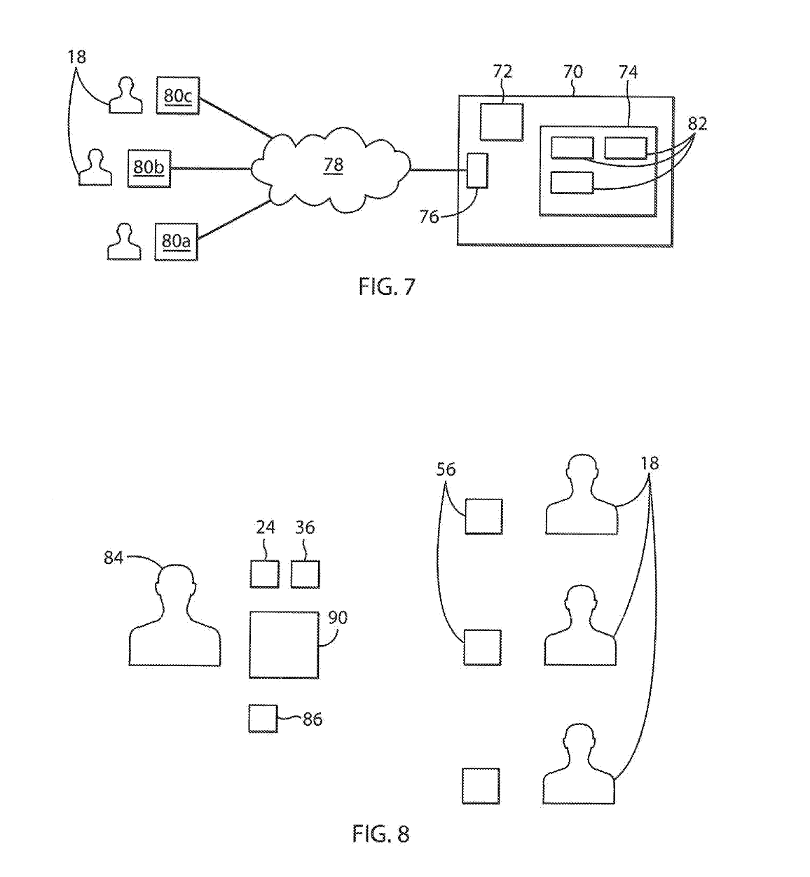

Referring now to FIG. 7, the present invention provides a game that may be implemented on an electronic computer, for example, on a server 70 having a processor 72 and memory 74 and communicating over a network interface 76 with the Internet 78 to multiple remote computers terminals 80a, 80b, and 80c. Each of the remote computer terminals 80 may allow for interaction with a gameplayer 18 or with other participants in the game. The memory 74 of the server 70 may hold various program modules 82 implementing, for example, the fantasy-league system 14 and the virtual contest system 12 as well as the reporting module 20 and contestant input module 22. The memory 74 may also hold data structures, for example, holding the data tables described above including contestant DNA table 24, environment tables 36, rosters 54, and the outcome tables 58. Each of the computer terminals 80 may also provide for a processor and an electronic memory for storing programs that may be executed by the processor, and operate to communicate with the server 70 for the exchange of data between gameplayers 18 and the server 70. Terminals 80 may also provide for input by human intermediaries working as the reporters 60 or to moderate contestant input module 22.

Alternatively, it will be appreciated that the present invention may be implemented as a set of forms and may be played by individuals without computer support. In this case gameplayers 18 may prepare printed paper forms providing rosters 54. A designated human contest master 84 may implement the contests, for example, using random input from dice 86 or the like following a set of rules 90 and information previously prepared in a DNA table 24 and environment tables 36 in the manner of popular games such as Dungeons & Dragons.

Referring again to FIG. 1, the virtual fantasy-league 10 will normally be associated with a back story 92, for example, a text and image file distributed to all gameplayers describing the back story of the various contests, for example, a science fiction back story or the like, that will generally be consistent with the game rules and contestant characteristics and environments.

Certain terminology is used herein for purposes of reference only. and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

The various tables described herein will be understood to be largely arbitrary divisions and a given table should be equivalent to multiple tables combining to provide the same information and multiple tables may be considered to be a single table combining the information of the multiple tables when logical equivalence is maintained.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What we claim is:

1. A virtual fantasy-league game system comprising:
at least one electronic computer executing a program stored in non-transient media to provide:
a contestant table listing contestant characteristics related to a virtual contest between contestants;
environment tables describing a series of virtual contests between a set of contestants;
roster tables providing for each gameplayer a roster of at least some of the set of contestants in a fantasy contest between contestants;
a random number generator;
a set of contest rules describing a determination of outcomes of the virtual contest using the contestant tables and environment tables together with random numbers from the random number generator to produce a set of statistics and
a set of fantasy rules describing a determination of the outcome of the fantasy contests using the set of statistics applied to the roster for each gameplayer.

2. The virtual fantasy-league game system of claim 1 wherein the contestant table lists contestant characteristics selected from the group consisting of intelligence, strength, health, and agility such as affect outcomes of the virtual contests according to the contest rules.

3. The virtual fantasy-league game system of claim 2 wherein the contestant table includes contestant health which decreases during a contest and recovers between contests.

4. The virtual fantasy-league game system of claim 1 wherein the contestant table further includes equipment available to the contestant, the equipment affecting the outcome of the virtual contests according to the contest rules.

5. The virtual fantasy-league game system of claim 4 wherein the electronic computer executing the stored program further provides equipment purchase rules providing for purchase by gameplayers of equipment assigned to specified contestants.

6. The virtual fantasy-league game system of claim 1 wherein the environment tables provide information about a location of a contest including at least one of weather and terrain type.

7. The virtual fantasy-league game system of claim 1 wherein the electronic computer executing the stored program further provides roster selection rules providing for distribution of contestants among the rosters of the gameplayers according to gameplayer input.

8. The virtual fantasy-league game system of claim 1 wherein statistics produced by the contest rules are output to the gameplayers.

9. The virtual fantasy-league game system of claim 8 wherein a portion of the statistics produced by the contest rules are provided to human reporters who provide stories characterizing some statistics not provided directly to the gameplayers.

10. The virtual fantasy-league game system of claim 1 further including a story arc table providing a set of weights for each contestant applicable to successive contests, the weights affecting outcome of the virtual contests according to the contest rules.
